(19) United States
(12) Patent Application Publication
(10) Pub. No.: US 2023/0198779 A1
(43) Pub. Date: Jun. 22, 2023

(54) PARTIAL SIGNATURES BASED ON ENVIRONMENTAL CHARACTERISTICS

(71) Applicant: Hewlett-Packard Development Company, L.P., Spring, TX (US)

(72) Inventors: Thalia Laing, Bristol (GB); Joshua Serratelli Schiffman, Washington, DC (US)

(73) Assignee: Hewlett-Packard Development Company, L.P., Spring, TX (US)

(21) Appl. No.: 17/997,177

(22) PCT Filed: May 4, 2020
(86) PCT No.: PCT/US2020/031290

§ 371 Date: Oct. 26, 2022

(51) Int. Cl. H04L 9/32; H04L 9/08; H04W 12/63; G06N 20/00

(52) U.S. Cl. CPC H04L 9/3247; H04L 9/085; H04L 9/3271; H04W 12/63; G06N 20/00

(57) ABSTRACT

An example system includes a policy engine to measure a local environmental characteristic and determine whether a security policy is satisfied based on the environmental characteristic. The system also includes a signature engine to generate a partial signature using a share of a shared secret based on the security policy being satisfied.

### BACKGROUND

Communication networks, such as the Internet, allow computing devices to access remote services. A service provider may want certain devices or users on a network to connect to a service while not allowing other devices or users to connect to the service. The network may allow both the wanted and unwanted users to communicate with the service provider. Accordingly, the service provider may implement an authentication scheme that allows selected users to connect to and use the service.

### BRIEF DESCRIPTION OF THE DRAWINGS

FIG. 1 is a block diagram of an example system to generate a partial signature based on an environmental characteristic.

FIG. 2 is a block diagram of another example system to generate a partial signature based on an environmental characteristic.

FIG. 3 is a flow diagram of an example method to generate a partial signature based on an environmental characteristic.

FIG. 4 is a flow diagram of another example method to generate a partial signature based on an environmental characteristic.

FIG. 5 is a flow diagram of an example method to issue new shares to a plurality of devices.

FIG. 6 is a block diagram of an example computer-readable medium including instructions that cause a processor to generate a partial signature based on an environmental characteristic.

FIG. 7 is a block diagram of another example computer-readable medium including instructions that cause a processor to generate a partial signature based on an environmental characteristic.

### DETAILED DESCRIPTION

Any of various authentication schemes may be implemented by a service provider. For example, a user may be authenticated based on something they know (e.g., a password), something they are (e.g., a biometric characteristic), or something they have. In an example, a user may be authenticated based on their possession of a device. The device may be a laptop, a mobile phone, a watch or other wearable, or the like. When a user wishes to authenticate with a relying party, such as to access a service, the device may generate a signature using a locally stored private key. The signature may evidence that the person wishing to authenticate is in possession of the device.

An attacker may attempt to get access to a service that restricts access with an authentication scheme. For example, the attacker may steal the credentials of a legitimate user, compromise a legitimate user's device, steal a legitimate user's device, or the like to gain access to the service. In the example of authentication based on possession of device, the attacker may gain possession or control of the device. The attacker may then be able to generate a signature proving possession of the device. Accordingly, the attacker may be able to access the service.

In an example, a device may determine whether a legitimate user is in possession of the device. The device may generate a signature using the private key if the device determines the legitimate user is in possession of the device, and the device may refuse to generate the signature using the private key (e.g., may not generate the signature) if the device determines the legitimate user is not in possession of the device. Thus, theft of the device may not allow an attacker to authenticate. An attacker in possession of the device may also be able to compromise the device. In addition, it may be expensive to add capabilities to the device to allow it to determine whether the legitimate user is in possession. Accordingly, an authentication scheme could be improved by an inexpensive device that makes it more difficult for an attacker in possession of a device to authenticate.

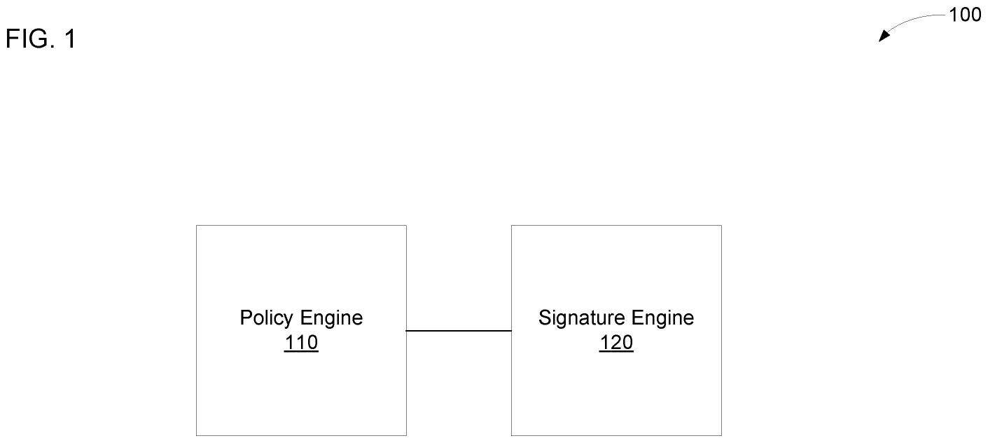

FIG. 1 is a block diagram of an example system 100 to generate a partial signature based on an environmental characteristic. The system 100 may include a policy engine 110 and a signature engine 120. As used herein, the term “engine” refers to hardware (e.g., analog or digital circuitry, a processor, such as an integrated circuit, or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random-access memory (RAM), a hard-disk or solid-state drive, resistive memory, or optical media such as a digital versatile disc (DVD), and/or executed or interpreted by a processor), or hardware and software hosted at hardware.

The policy engine 110 may measure a local environmental characteristic. The environmental characteristic may include anything that the system 100 can measure about its environment. For example, the environmental characteristic can include electromagnetic radiation (e.g., light, radio waves, etc.), temperature, sound, pressure, motion (e.g., motion imparted to the system by a user), system location, presence or concentration of a particular chemical (e.g., humidity, pollution, etc.), or the like. The environmental characteristic may be local. As used herein, the term “local environmental characteristic” refers to an environmental characteristic that is able to be sensed by the system 100. For example, for a distributed system, all components of the system and the location of the sensing may be within a predetermined distance of each other, such as 10 centimeters (cm), 50 cm, 1 meter (m), 5 m, 10 m, 20 m, etc.

The police engine 110 may also determine whether a security policy is satisfied based on the environmental characteristic. The security policy may be specified by a relying party, an organization associated with the user (e.g., an employer), or the like. The security policy may specify the circumstances under which the system should or should not contribute to authentication of the user. For example, the security policy may specify whether or not to contribute to authentication of the user for the particular value of the local environmental characteristic that was measured.

The signature engine 120 may generate a partial signature using a share of a shared secret based on the security policy being satisfied. As used herein, the term “shared secret” refers to information that can be divided into shares. Each share may not be usable in isolation to determine the value of another share, and each share may be usable to generate a partial signature that is not usable in isolation to determine the value of a share nor the shared secret. As used herein, the term “share” refers to one of a plurality of pieces of information generated from the shared secret. As used herein, the term “partial signature” refers to a signature generated based on a share. The partial signature may have the property that the share is significantly more computationally difficult to determine from the partial signature than the partial signature is to determine from the share. The system 100 or the signature engine 120 may store a share. In response to the policy engine 110 determining that the security policy is satisfied, the signature engine 120 may generate the partial signature using the share.

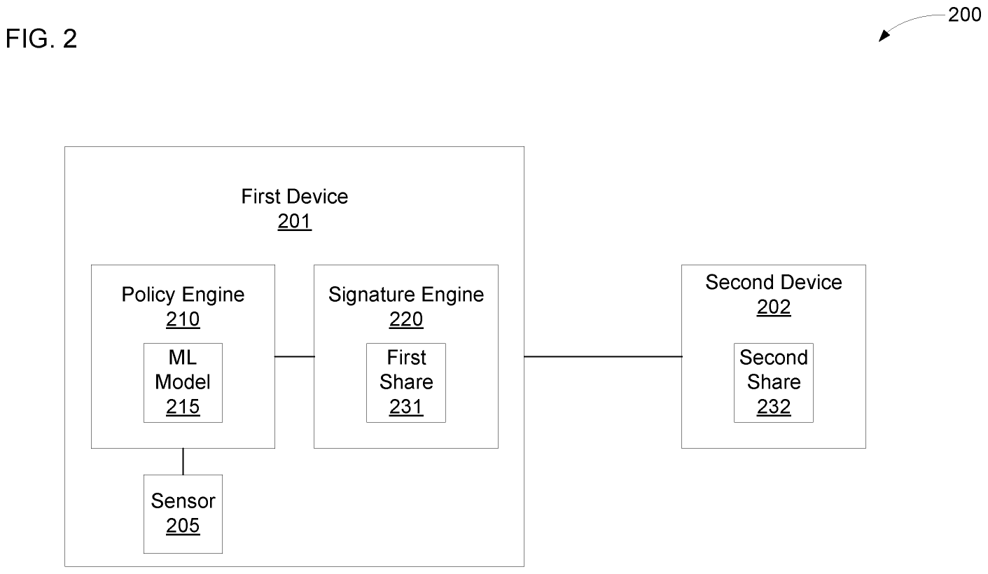

FIG. 2 is a block diagram of another example system 200 to generate a partial signature based on an environmental characteristic. The example system 200 includes a first device 201 and a second device 202. A user may wish to use a service. Accordingly, the second device 202 may communicate with a remote system and request to authenticate with the service so that the user can utilize the service. In response, the second device 202 may receive a challenge from the service. The challenge may include information to be used by the first or second device 201, 202 to generate a response. For example, the challenge may include information to be signed with a partial signature. In the illustrated example, the second device 202 may provide the challenge to the first device 201. In other examples, the first device 201 may receive the challenge directly from the remote system without receiving the challenge from the second device 202. The second device 202 may include a second share 232 of a shared secret (e.g., stored in a computer-readable medium). The second device 202 may generate a second partial signature of the challenge using the second share 232. The second device 202 may communicate the second partial signature to the remote system.

The first device 201 may receive the challenge from the second device 202 (or the remote system). The first device 201 may include a policy engine 210. In response to the first device 201 receiving the challenge, the policy engine 210 may measure a local environmental characteristic. In the illustrated example, the first device 201 includes a sensor 205 communicatively coupled to the policy engine 210. In other examples, the system 200 or the first device 201 may not include the sensor 205. Rather, the sensor 205 may be communicatively coupled to the first device 201. The policy engine 210 may measure the local environmental characteristic by receiving a measurement from the sensor 205, by measuring an electrical signal resulting from changes to the sensor 205 due to the environment, or the like. The policy engine 210 and the sensor 205 may cooperate to measure electromagnetic radiation (e.g., light, radio waves, etc.), temperature, sound, pressure, motion (e.g., motion imparted to the system by a user), system location, presence or concentration of a particular chemical (e.g., humidity, pollution, etc.), or the like.

In some examples, the environmental characteristic may include an environmental characteristic usable to detect a location of the device. For example, the policy engine 210 and the sensor 205 may detect the location based on wireless signals near the first device 201, based on a satellite navigation signal, or the like. The policy engine 210 and the sensor 205 may measure signal strength of a wireless signal or may determine service set identifiers (SSIDs), media access control (MAC) addresses, Bluetooth device addresses, etc. for nearby wireless access points or devices. In some examples, the policy engine 210 and the sensor 205 may measure environmental characteristics corresponding to voluntary or involuntary user behavior or environmental characteristics indicative of whether a user is present with the device. For example, the policy engine 210 may measure motion, sound, camera images, etc. captured by the sensor 205.

The policy engine 210 may determine whether a security policy is satisfied based on the environmental characteristic. The security policy may be explicitly or implicitly defined for the policy engine 210. For example, an explicit security policy may include a set of rules or criteria to be satisfied for the security policy to be satisfied. The set of rules or criteria may be included in a set of processor-executable instructions or may be interpretable by instructions executing on a processor. The policy engine 210 evaluate the measured local environmental characteristics according to the set of rules or criteria to determine whether the security policy is satisfied.

The policy engine 210 may evaluate an implicit security policy. In the illustrated example, the policy engine 210 includes a machine learning (ML) model 215 that defines the implicit security policy. The machine learning model 215 may receive the environmental characteristic as an input. For example, the policy engine 210 or the machine learning model 215 may translate the measurement of the local environmental characteristic into a feature vector. The machine learning model 215 may generate an indication of whether the security policy is satisfied. In an example, the machine learning model 215 may generate a value (e.g., a softmax value) indicative of the risk. The policy engine 210 may compare the value indicative of the risk to a threshold to determine whether the security policy is satisfied.

The machine learning model 215 may be trained to determine whether the environmental characteristic indicates a security risk. The training of the machine learning model 215 may specify the security policy, which may be reflected in the configuration (e.g., neural network weights) of the machine learning model. The training may include supervised learning (e.g., particular environmental characteristics are labeled as satisfying or not satisfying the security policy) or unsupervised learning (e.g., a loss function that maximizes the distance between involuntary user behaviors).

The policy engine 210 may evaluate an explicit security policy and an implicit security policy, evaluate an explicit security policy without evaluating an implicit security policy, or evaluate an implicit security policy without evaluating an explicit security policy. For example, the set of rules or criteria of an explicit security policy may include a rule related to the output of a machine learning model incorporating an implicit security policy, a set of rules or criteria may be used to generate a feature vector that is input into a machine learning model, or the like.

The policy engine 210 may evaluate a usage pattern of a user (e.g., is a user behaving typically, is a user still present, etc.), an aspect of the environment unrelated to the user, or the like based on an explicit or implicit security policy. The policy engine 210 may determine whether the environmental characteristic is consistent with typical user behavior, such as typical user behavior of a specific user, with typical user behavior of legitimate users, or the like. For example, the explicit or implicit security policy may specify environmental characteristics of users behaving in an atypical or malicious manner. The policy engine 210 may also, or instead, determine whether the environmental characteristic is consistent with a user being present. For example, the policy engine 210 may determine whether the environmental characteristic is indicative of the device leaving the user's possession since the last time the security policy was satisfied or the user otherwise proved the user's presence. The policy engine 210 may also determine whether an aspect of the environment unrelated to the user is consistent with a typical condition for that aspect of the environment. For example, the policy engine 210 may determine whether the location or type of location is consistent with typical locations or types of location.

The security policy may be predetermined or may be generated based on usage. For example, a relying party or an organization may define a security policy by specifying the set of rules or criteria for an explicit security policy or the configuration (e.g., neural network weights) of an implicit security policy. The security policy may be generated based on usage patterns, for example, by using measurements of environmental characteristics when a user has proved the user's presence (e.g., authenticated) as positive training samples. Negative samples may be provided by the user, a relying party, an organization associated with the user (e.g., an organization specifying aspects of the security policy, such as an employer, a school, etc.), another trusted organization, or the like. The policy engine 210 may generate a user profile based on the positive and negative samples. The policy engine 210 may compare the measured environmental characteristics to the user profile when evaluating an explicit security policy. The policy engine 210 may train the machine learning model 215 based on the positive and negative samples instead of or in addition to generating a user profile.

In some examples, the system 200 may be associated with a user. The security policy may be generated (in advance or during usage) specifically for that user. In some examples, the system 200 may be associated with a role. For example, the system 200 may be stored in a locker. Users with a particular role may be able to retrieve the system 200 from the locker and use the system 200. The policy may be generated (in advance or during usage) for users having the particular role.

The first device 201 may include a signature engine 220. The signature engine 220 may include a first share 231 of a shared secret (e.g., stored in a computer-readable medium) or may be able to retrieve the first share 231 from a computer-readable medium. Based on the policy engine 210 determining the security policy is satisfied, the signature engine 220 may generate a first partial signature using the first share 231. For example, the signature engine 220 may generate a first partial signature of the challenge using the first share 231. The signature engine 220 may communicate the first partial signature to the second device 202 or may communicate the first partial signature directly to the remote system without communicating the challenge to the second device 202. The signature engine 220 may not generate the first partial signature in response to the security policy not being satisfied.

In some examples, in response to the security policy not being satisfied, the signature engine 220 may prompt the user to provide authentication information. For example, the user may have a password or personal identification number (PIN) that can be used to authenticate the user, may biometrically authenticate, or the like. The signature engine 220 may determine whether the authentication information is correct. In response to a determination the authentication information is correct, the signature engine 220 may generate the first partial signature using the first share 231. In some examples, the authentication process may have properties that make it more onerous to use than relying on the policy engine 210. For example, the password or PIN may be a recovery password or PIN that cannot be used again for a predetermined period once entered, that is different each authentication, that is too long to memorize, or the like. The signature engine 220 or the policy engine 210 may report to a remote system if a user repeatedly fails to satisfy the security policy and authenticates instead (e.g., a predetermined number or percentage of failures occur) or may lock out the user in such circumstances.

In some examples, the signature engine 220 may prompt the user to authenticate when the user begins using the system 200. The signature engine 220 may prompt the user to authenticate if the user walks away from the system 200 or does something unusual detected by the policy engine 210. The signature engine 220 may indicate to the policy engine 210 when the user has authenticated successfully. The policy engine 210 may determine positive samples or a user profile in response to the user authenticating successfully.

Various relationships between the first device 201 and the second device 202 are possible. In an example, the first device 201 may be mechanically coupled to a motherboard of the second device 202. For example, the first device 201 may be glued to the motherboard, screwed to the motherboard, or otherwise permanently or removably attached to the mother board. In an example, the first device 201 may be connected to a universal serial bus (USB) port of the second device 202. In some examples, the first device 201 may be separate from the second device 202 (e.g., not attached to the second device 202). The first device 201 may be carried (e.g., in a bag, a pocket, etc.) or worn by a user who is also using the second device 202. The first device 201 may communicate with the second device 202 via a wired connection, a wireless connection (e.g., a low bandwidth communication protocol, such as a Bluetooth low energy (BLE) protocol, a near field communication (NFC) protocol, etc.), or the like.

In some examples, the relying party may implement a two of two scheme in which there are two shares 231, 232 and no additional shares beyond those two shares and in which a user is authenticated when two partial signatures are provided. In another example, the relying party may implement an N of N scheme in which there are N shares, N is greater than or equal to two, and the user is authenticated when N partial signatures are provided. By making the number of partial signatures to authenticate equal to the number of shares, the user may not be able to authenticate without using the first share (and thus the first device if no other copies of the first share are accessible). In some examples, the relying party may implement a t of N scheme in which there are N shares and the user is authenticated when t partial signatures are provided. The value of t may be less than the value of N. The relying party may implement a cryptographic access structure that includes multiple groups with different policies, such as an N of N scheme for a first group of devices that includes the first device 201 and a t of N scheme for second group of devices that does not include the first device 201, with the user being authenticated if the policy of each and every group is satisfied.

There may be scenarios in which a user loses the first device or wishes to replace the first device with a new or alternate implementation of the first device. Accordingly, a share dealing device may generate a new shared secret and a new set of shares and may distribute the new shares. For example, the share dealing device may generate a new first share and a new second share. The share dealing device may transmit the new second share to the second device 202 and may transmit the new first share to a third device (not shown). The third device may include a policy engine and a signature engine similar to those of the first device 201. The share dealing device may be the second device 202 (in which case the second device 202 may store the new second share rather than transmitting it to the second device 202) or a remote device.

Including the first device 201 in an authentication scheme may ensure the inherent enforcement of a security policy due to authentication being based on the ability to generate the first partial signature. The security policy cannot be undermined by compromising the second device 202. The second device 202 does not manage the security policy, does not have access to the first share, and does not receive a key or other private cryptographic information that could be attacked. In addition, the first device 201 can be an inexpensive device with limited capabilities. The first device 201 provides an inexpensive way to make it more difficult for an attacker in possession of the second device 202 to authenticate.

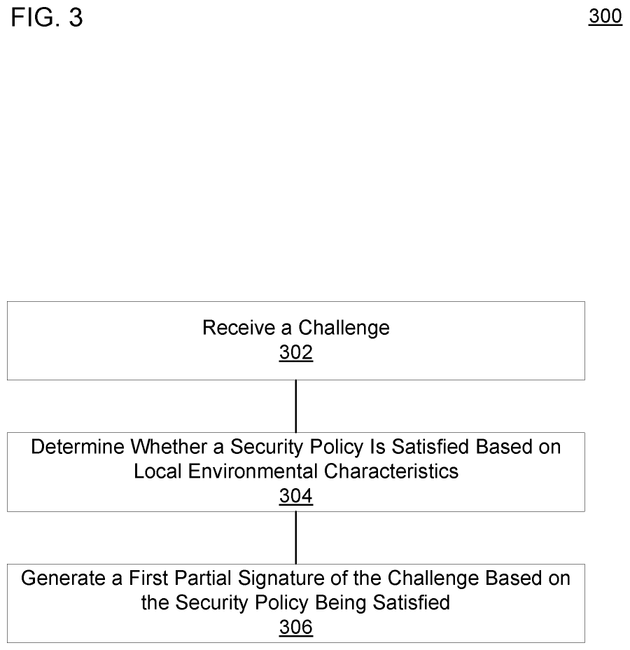

FIG. 3 is a flow diagram of an example method 300 to generate a partial signature based on an environmental characteristic. A processor may perform elements of the method 300. At block 302, the method 300 may include receiving a challenge. For example, a user may wish to authenticate with a service, and the challenge may be received from the service. The challenge may include information that is to be used to generate a response to the challenge.

At block 304, the method 300 may include determining whether a security policy is satisfied based on a local environmental characteristic. The security policy may be explicit or implicit. The security policy may specify the conditions (as indicated by the local environmental characteristic) under which the user should be authenticated. The security policy may be evaluated using measurements of the local environmental characteristic to determine whether the security policy is satisfied.

At block 306, the method 300 may include generating a first partial signature of the challenge using a first share of a shared secret based on the security policy being satisfied. The first partial signature may be generated in cases where the security policy is satisfied and not generated in cases where the security policy is not satisfied. Generating the first partial signature may include signing the challenge or information from the challenge with the first share of the shared secret. The first partial signature can then be used to contribute to authentication of the user. Referring to FIG. 1, in an example, the policy engine 110 may perform block 304, and the signature engine 120 may perform blocks 302 and 306.

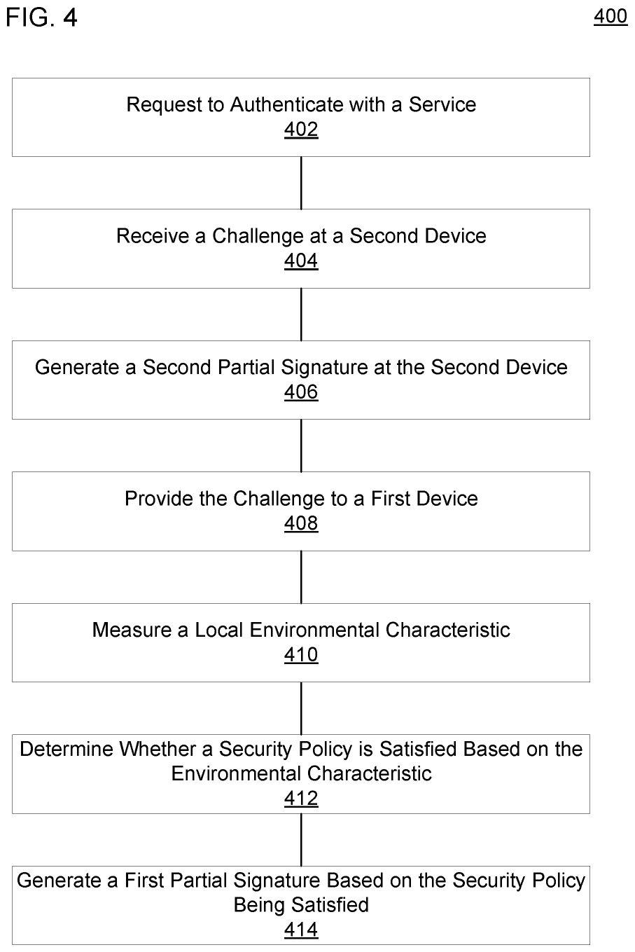

FIG. 4 a flow diagram of another example method 400 to generate a partial signature based on an environmental characteristic. A processor may perform elements of the method 400. At block 402, the method 400 may include requesting to authenticate with a service. For example, a second device may communicate a request to authenticate to the service. The second device may communicate the request to authenticate in response to input from the user.

Block 404 may include receiving a challenge. For example, the second device may receive the challenge from the service. The challenge may include information that is to be used to generate a response to the challenge. At block 406, the method 400 may include generating a second partial signature of the challenge using a second share at the second device. For example, the second device may sign the information from the challenge using the second share to generate the second partial signature. The second device may communicate the second partial signature to the service.

Block 408 may include providing the challenge to a first device. As previously discussed, the first device may be communicatively coupled to the second device by a wired connection, a wireless connection, or the like. The second device may provide the challenge over the communicative coupling. In other examples, the first device may receive the challenge from the service without the second device assisting to communicate the challenge to the first device.

At block 410, the method 400 may include measuring a local environmental characteristic. The first device may measure the local environmental characteristic or receive the local environmental characteristic from another device that performs the measurement. The local environmental characteristic may include any of the previously discussed environmental characteristics, such as a usage pattern, an aspect of the environment unrelated to the user, or the like. In an example, measuring the local environmental characteristic may include detecting a location of a device (e.g., the first device or the second device), for example, by detecting wireless signals near the device. The location may be determined based on signal strength, SSIDs, MAC addresses Bluetooth device addresses, or the like.

Block 412 includes determining whether a security policy is satisfied based on the local environmental characteristic. For example, for an explicit security policy, the measurement of the local environmental characteristic may be evaluated according to a set of rules or criteria to determine whether the measurement satisfies the security policy. For an implicit security policy, the measurement may be input into a machine learning model (e.g., after conversion to a feature vector), and the machine learning model may output an indication of whether the security policy is satisfied (e.g., a value that can be compared to a threshold to determine whether the security policy is satisfied).

At block 414, the method 400 may include generating a first partial signature of the challenge using a first share of a shared secret based on the security policy being satisfied. For example, the first device may generate the first partial signature by signing the information from the challenge using the first share. The first device may generate the first partial signature in response to the security policy being satisfied and not generate the first partial signature in response to the security policy not being satisfied. The first device may communicate the first partial signature to the second device or communicate the first partial signature to the service without communicating it to the second device. The service may authenticate a user based on receiving the first and second partial signatures. In an example, the second device 202 of FIG. 2 may perform block 402, 404, 406, and 408, the policy engine 210 or the sensor 205 may perform block 410, the policy engine 210 may perform block 412, and the signature engine 220 may perform block 414.

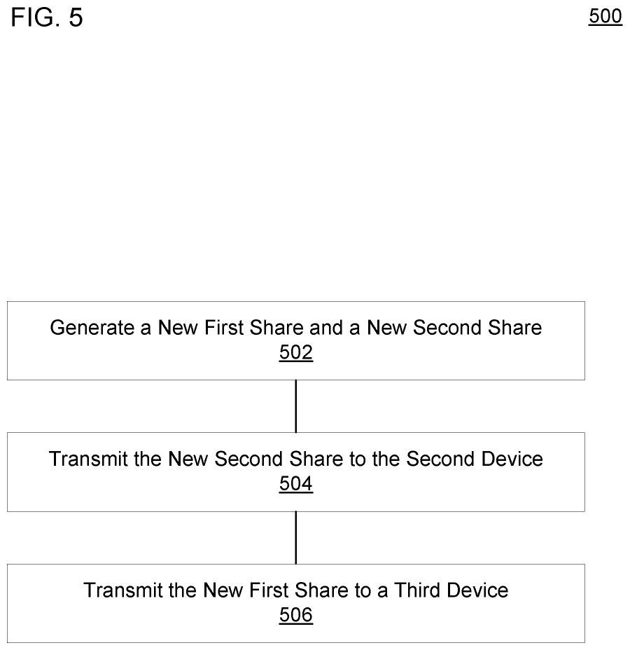

FIG. 5 is a flow diagram of an example method 500 to issue new shares to a plurality of devices. A processor may perform elements of the method 500. In cases where a device (e.g., the system 100 of FIG. 1 or the first device 201 of FIG. 2) is lost or replaced, the method 500 may be used to allow authentication with a new device. At block 502, the method 500 may include generating a new first share and a new second share. For example, generating the new first share and the new second share may include generating a new shared secret. The new shared secret may be generated randomly while ensuring the shared secret satisfies criteria for cryptographic security. For example, possible shared secrets may be generated until one is identified that satisfies the criteria for cryptographic security. The new shared secret may be split into a plurality of shares including the new first share and the new second share.

Block 504 may include transmitting the new second share to a second device. For example, the second device may be a personal computing device, such as a laptop, a mobile phone, a watch, or the like. The new second share may be communicated to the second device over a secure channel, and the second device may store the new second share in a secure location, such as computer-readable medium associated with or included in a trusted platform module (TPM).

At block 506, the method 500 may include transmitting the new first share to a third device. The third device may be a replacement for a first device. The third device may include the policy engine 110, 210 or the signature engine 120, 220 of FIG. 1 or FIG. 2. The new first share may be communicated to the third device directly or communicated to the third device via the second device. In some examples, transmitting the new first share to the third device may include initially confirming the third device is able to enforce a selected security policy.

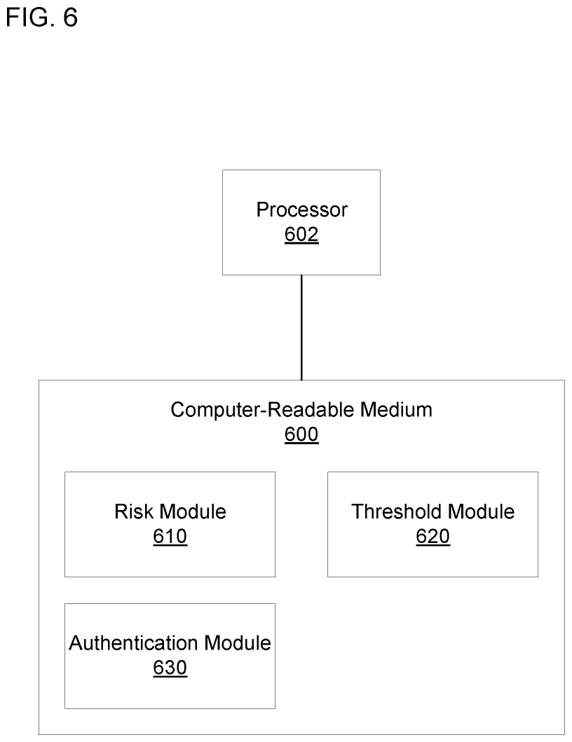

FIG. 6 is a block diagram of an example computer-readable medium 600 including instructions that, when executed by a processor 602, cause the processor 602 to generate a partial signature based on an environmental characteristic. The computer-readable medium 600 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like. The processor 602 may be a general-purpose processor or special purpose logic, such as a microprocessor (e.g., a central processing unit, a graphics processing unit, etc.), a digital signal processor, a microcontroller, an ASIC, an FPGA, a programmable array logic (PAL), a programmable logic array (PLA), a programmable logic device (PLD), etc.

The computer-readable medium 600 may include a risk module 610, a threshold module 620, and an authentication module 630. As used herein, a “module” (in some examples referred to as a “software module”) is a set of instructions that when executed or interpreted by a processor or stored at a processor-readable medium realizes a component or performs a method. The risk module 610 may include instructions that, when executed, cause the processor 602 to generate an indication of risk using a machine learning model based on a measurement of an environmental characteristic. For example, the processor 602 may implement a machine learning model that takes the measurement of the environmental characteristic as an input and generates the indication of risk as an output. The machine learning model may be trained to determine whether the environmental characteristic indicates a security risk. For example, the machine learning model may have been trained previously to distinguish between measurements of an environmental characteristic that indicate a security risk and measurements that do not.

The threshold module 620 may cause the processor 602 to determine whether the indication of risk satisfies a threshold. For example, the indication of risk may be a numerical value. The threshold module 620 may cause the processor 602 to compare the value to the threshold. The threshold may be satisfied based on the value being greater than, at least, no greater than, or less than the threshold.

The authentication module 630 may cause the processor 602 to contributed to authentication of a user based on the indication of risk satisfying the threshold. For example, the authentication module 630 may cause the processor 602 to contribute to authentication in response to the indication of risk satisfying the threshold and to not contribute to authentication in response to the indication of risk not satisfying the threshold. The authentication module 630 may cause the processor 602 to contribute to authentication of the user by generating information that is usable to authenticate the user (e.g., information usable in combination with other information to authenticate the user). In an example, when executed by the processor 602, the risk module 610 and the threshold module 620 may realize the policy engine 110 of FIG. 1 and the authentication module 630 may realize the signature engine 120.

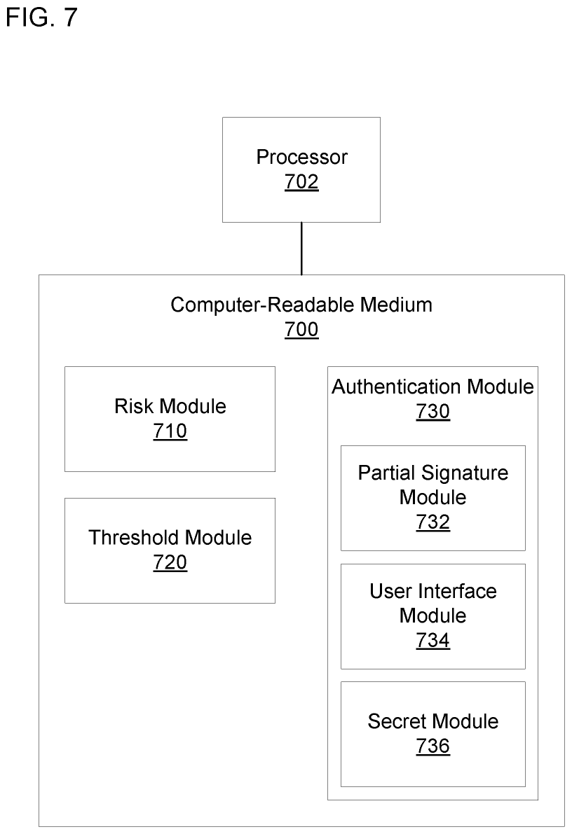

FIG. 7 is a block diagram of another example computer-readable medium 700 including instructions that, when executed by a processor 702, cause the processor 702 to generate a partial signature based on an environmental characteristic. The computer-readable medium 700 may include a risk module 710, a threshold module 720, and an authentication module 730. The authentication module 730 may include a partial signature module 732, a user interface module 734, and a secret module 736.

The risk module 710 may include instructions that cause the processor 702 to generate an indication of risk using a machine learning model based on a measurement of an environmental characteristic. The machine learning model may be a neural network, a support vector machine, or the like. The environmental characteristic may include any of the environmental characteristics previously discussed, such as a usage pattern, an aspect of the environment unrelated to the user, or the like. In an example, the measurement may be of an involuntary user behavior, such as a movement pattern (e.g., a gait, a habitual movement, etc.), a biometric behavior (e.g., a galvanic skin response, pulse, etc.), or the like. The risk module 710 may cause the processor 702 to convert the measurement of the environmental characteristic into a feature vector. The risk module 710 may cause the processor 702 to use the feature vector as an input to the machine learning model. The risk module 710 may cause the processor 702 to generate a numerical value as an output from the machine learning model (e.g., a softmax value). The output from the machine learning model may be the indication of risk. The risk module 710 may cause the processor 702 to generate the indication of risk in response to receiving a challenge.

The threshold module 720 may cause the processor 702 to determine whether the indication of risk satisfies a threshold. For example, for a machine learning model that generates a softmax output, the threshold may be a value between 0 and 1. The threshold may be a value, such as a predetermined value, selected by a relying party, an organization to which the user belongs, a service, or the like. Similarly, the relying party may specify what constitutes satisfaction of the threshold. For example, the threshold module 720 may cause the processor 702 to determine whether the value is greater than, at least, no greater than, or less than the threshold.

The authentication module 730 may cause the processor 702 to contribute to authentication of a user based on the indication of risk satisfying the threshold. In the illustrated example, the authentication module 730 includes a partial signature module 732. To contribute to authentication, the partial signature module 732 may cause the processor 702 to generate a partial signature using a share of a shared secret. For example, the partial signature module 732 may cause the processor 702 to generate the partial signature in any of the manners previously discussed. The partial signature module 732 may cause the processor 702 to generate the partial signature in response to the indication of risk satisfying the threshold.

In response to the indication of risk not satisfying the threshold, the partial signature module 732 may not initially cause the processor 702 to generate the partial signature. In the illustrated example, the authentication module 730 includes a user interface module 734. The user interface module 734 may cause the processor 702 to prompt the user to provide authentication information based on the indication of risk not satisfying the threshold. For example, the user interface module 734 may cause the processor 702 to cause a user interface to request the authentication information from the user and receive the authentication information. A device that includes the computer-readable medium 700 and the processor 702 may include the user interface, or the user interface module 734 may cause the processor 702 to instruct another device to prompt the user. The authentication information may a password, a PIN, or the like.

The secret module 736 may cause the processor 702 to determine whether the authentication information is correct. For example, the secret module 736 may cause the processor 702 to compare the authentication information to a stored version of the authentication information (e.g., a hashed version of the authentication information). The secret module 736 may cause the processor 702 to determine whether the authentication information received from the user corresponds to the stored version of the authentication information (e.g., whether a hash of the received authentication information matches a stored hash).

The authentication module 730 may cause the processor 702 to contribute to authentication of the user based on a determination the authentication information is correct. For example, the partial signature module 732 may cause the processor 702 to generate the partial signature using the share of the shared secret in response to a determination the authentication information is correct. Thus, the partial signature module 732 may cause the processor 702 to generate the partial signature in response to the indication of risk satisfying the threshold or in the response to the indication of risk not satisfying the threshold but the authentication information being correct. The partial signature module 732 may cause the processor 702 to not generate the partial signature in response to the indication of risk not satisfying the threshold and the authentication information not being correct.

In some examples, the partial signature module 732 may cause the processor 702 to generate the partial signature based on a share that is one of two shares of a shared secret. The user may be authenticated by a relying party when partial signatures corresponding to both shares are received and not authenticated when fewer partial signatures are received. In some examples, the share may be one of N shares, and the user may not be authenticated when fewer than N partial signatures corresponding to the N shares are received. Accordingly, the relying party may not authenticate the user unless a partial signature is received from the partial signature module 732. In other examples, there may be N shares, and the user may be authenticated by fewer than N partial signatures. Referring to FIG. 2, in an example, when executed by the processor 702, the risk module 710 and the threshold module 720 may realize the policy engine 210, and the authentication module 730, the partial signature module 732, the user interface module 734, and the secret module 736 may realize the signature engine 220.

The above description is illustrative of various principles and implementations of the present disclosure. Numerous variations and modifications to the examples described herein are envisioned. Accordingly, the scope of the present application should be determined only by the following claims.

What is claimed is:

1. A system comprising:
a policy engine to:
measure a local environmental characteristic, and
determine whether a security policy is satisfied based on the environmental characteristic; and
a signature engine to generate a partial signature using a share of a shared secret based on the security policy being satisfied.

2. The system of claim 1, wherein the policy engine includes a machine learning model to receive the environmental characteristic as input and generate an indication of whether the security policy is satisfied.

3. The system of claim 2, wherein the machine learning model is trained to determine whether the environmental characteristic is consistent with a user being present and typical user behavior.

4. The system of claim 1, further comprising a first device comprising the policy engine and the signature engine, and a second device comprising an additional share of the shared secret.

5. The system of claim 4, wherein the first device is mechanically coupled to a motherboard of the second device or communicatively coupled to the second device via a low bandwidth communication protocol.

6. A method, comprising:
receiving a challenge;
determining, using a processor, whether a security policy is satisfied based on a local environmental characteristic;
generating, using the processor, a first partial signature of the challenge using a first share of a shared secret based on the security policy being satisfied.

7. The method of claim 6, further comprising:
requesting to authenticate with a service, wherein receiving the challenge comprises receiving the challenge from the service at a second device;
generating a second partial signature of the challenge using a second share at a second device; and
providing the challenge to a first device, wherein the generating of the first partial signature is at the first device.

8. The method of claim 6, further comprising:
generating a new first share and a new second share;
transmitting the new second share to a second device; and
transmitting the new first share to a third device.

9. The method of claim 6, further comprising measuring the environmental characteristic, wherein measuring the environmental characteristic includes detecting a location of a device.

10. The method of claim 9, wherein detecting the location of the device comprises detecting wireless signals near the device.

11. A non-transitory computer-readable medium comprising instructions that, when executed by a processor, cause the processor to:
generate an indication of risk using a machine learning model based on a measurement of an environmental characteristic, wherein the machine learning model is trained to determine whether the environmental characteristic indicates a security risk;
determine whether the indication of risk satisfies a threshold; and
based on the indication of risk satisfying the threshold, contribute to authentication of a user.

12. The computer-readable medium of claim 11, wherein the instructions that cause the processor to contribute to authentication of a user include instructions that cause the processor to generate a partial signature using a share of a shared secret.

13. The computer-readable medium of claim 12, wherein the shared secret includes two shares.

14. The computer-readable medium of claim 11, wherein the measurement of the environmental characteristic includes a measurement of an involuntary user behavior.

15. The computer-readable medium of claim 11, further comprising instructions that cause the processor to:
based on the indication of risk not satisfying the threshold, prompt the user to provide authentication information;
determine whether the authentication information is correct; and
based on a determination the authentication information is correct, contribute to authentication of the user.
